(19) United States
(12) Patent Application Publication
(10) Pub. No.: US 2013/0079067 A1
(43) Pub. Date: Mar. 28, 2013

(54) SUBLIMATION COATED CASE FOR CELL PHONE

(71) Applicant: James Peng, Sunnyvale, CA (US)

(72) Inventor: James Peng, Sunnyvale, CA (US)

(73) Assignee: Photo U.S.A. Corporation, Sunnyvale, CA (US)

(21) Appl. No.: 13/243,831

(22) Filed: Sep. 23, 2011

(51) Int. Cl. H04W 88/02

(52) U.S. Cl. 455/575.1

(57) ABSTRACT

A decorative case is provided for a cellular phone having a predetermined shape. The case has a back portion, opposing sides and opposing ends configured to closely fit over the back and sides of the cellular phone. The back portion has an outwardly facing, substantially flat portion. A supporting sheet has an inner surface adhered to the substantially flat portion and has an outward facing portion having a sublimation image thereon. The image is personally selected by the owner of the case. The supporting sheet is made of metal.

### BACKGROUND

The present invention relates generally to cases for cellular phones with images thereon, and more particularly to an improved method and apparatus for applying heat transferable images to sheets which may be fastened to cellular phone cases.

Cell phone cases are sold with images that are printed on fabric-coated cell phone cases. But these images wear easily as they are on fabric, and many users carry their cell phones in their pockets so that the removal and insertion of the phone into the pocket wears the image and fabric resulting in a degraded image and dissatisfaction with the product. Also, the fabric rubs against the clothing and pocket making it difficult to insert and retrieve the cell phone and casing. There is thus a need for cell phone case which has a custom image that is durable and does not impede insertion into or removal from a person's pocket.

### BRIEF SUMMARY

A method and apparatus are provided for of applying a sublimation transfer image to a support sheet such as a thin sheet of material, including metal (e.g., aluminum) or suitable plastic (e.g., acrylic) or other material suitable for fastening to the desired object as described herein. The support sheet is advantageously fastened to an adhesive layer on a casing configured to hold a cellular phone, such as an I-phone. The image can be printed by inserting cartridges containing sublimation dyes into a printer associated with a computer and then printing a custom, user selected image onto a transfer sheet, where the image is formed using sublimation dyes from the printer. The transfer sheet is then air dried until the sublimation ink is dry. The transfer sheet and sublimation image are then placed against the support sheet which is made of a material suitable for receiving the sublimation transfer image. The image and support are heated to transfer the sublimation image to the support. The transfer sheet is removed, and the support sheet is then fastened to a case configured to enclose a cellular phone.

Advantageously, the case has an area configured to receive the support sheet, and preferably an entire outer facing surface of the case is configured to receive the support sheet.

Advantageously, the outer facing surface is flat and covered with an adhesive. Alternatively, the support sheet may have an adhesive applied thereto. The outer facing surface of the phone case preferably aligns with the back side or back surface of a cellular phone.

A decorative case is provided for a cellular phone having a predetermined shape. The case has a back portion having a back, opposing sides and opposing ends configured to closely fit over the back and sides of the cellular phone. The back portion has an outwardly facing, substantially flat portion. A supporting sheet has an inner surface adhered to the substantially flat portion and also has an outward facing portion having a sublimation image thereon. The sublimation image is selected by the user of the case.

In further variations, the substantially flat portion covers the entire back of the cellular phone. Advantageously, the supporting sheet is made of metal, preferably of aluminum.

There is also advantageously provided a kit for decorating a case for a cellular phone. The phone has a predetermined shape. The kit includes a back portion of a cellular phone case having a back, opposing sides and opposing ends configured to closely fit over the back of the cellular phone. The back portion has an outwardly facing, substantially flat portion. The kit also includes a supporting sheet configured to conform to the shape of the substantially flat portion, the supporting sheet having an outward facing portion having a surface adapted to receive a sublimation colorant. The kit also includes an adhesive on one of the substantially flat portion or the supporting sheet. There is also a removable layer covering the adhesive.

In further variations, the kit can include a transfer sheet having a surface for receiving sublimation transfer colorants and having a portion conforming to the shape of the substantially flat portion. Further, the supporting sheet may have a sublimation image on the surface adapted to receive the sublimation colorant. Moreover, the substantially flat portion can covers the entire back of the cellular phone. The adhesive can be on the substantially flat portion or on the supporting sheet. The supporting sheet can be is made of any material adapted to receive sublimation coatings, including, but not limited to metals (e.g., aluminum), plastics, acrylics and other polymers. The kit can also include a top portion of the case configured to releasably fasten to the bottom portion to enclose the cellular phone within the top and bottom portions of the housing. The kit may include a support sheet with an opening therein located to coincide with a camera lens on the cellular phone.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded, perspective view of a bottom portion of a cellular phone case having an outer facing surface and a support sheet bearing an image thereon;

FIG. 2 is an end view of the case of FIG. 1, with a support sheet adhered thereto;

FIG. 3 is perspective view of the phone case of FIG. 1 from the opposing side showing the inside of the bottom portion of the case, and an opposing top portion of the case;

FIG. 4 is a side partial sectional view showing an iron heating a sublimation image to transfer the image to the support sheet of FIG. 1;

FIG. 5 is a perspective view of a plurality of support sheets and images being placed into an oven with a press plate to apply pressure during heating.

FIG. 6 is a perspective view of a computer, scanner, printer and heat transfer press that may affix an image to the case of FIG. 1;

FIG. 7 is a cross sectional view of a portion of the case of FIG. 1 with a sublimation coating thereon;

FIG. 8 is a cross sectional view of a portion of the case of FIG. 1 with a sublimation coating and an opaque layer;

FIG. 9 is another cross sectional view of a portion of the case of FIG. 1 with a sublimation coating and an opaque layer thereon; and

FIG. 10 shows a phone case having curved sides with a support sheet having a conforming shape.

### DETAILED DESCRIPTION

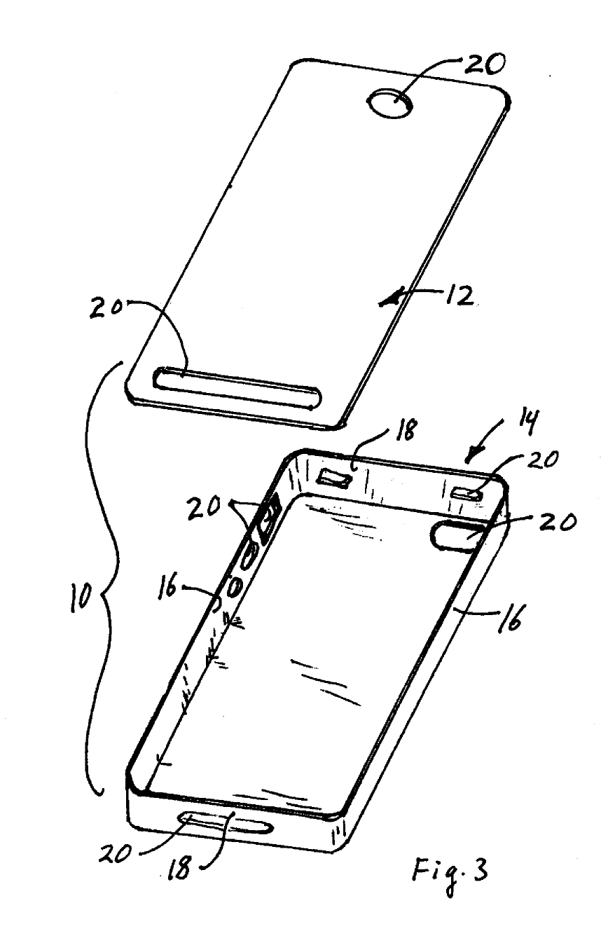

Referring to FIGS. 1-4, a phone case 10 has a top 12 and a bottom 14 with sides 16 and ends 18. Depending on the design, one or more of the sides 16 and ends 18 could be fastened to the top 12. The case 10 is configured to closely enclose a cellular phone (not shown) with various openings 20 located to allow access to various portions of the cellular phone to activate controls or to allow passage of audible signals or sounds. For example, in FIG. 1, the opening 20 in the sheet 22 is located to coincide with a camera lens on the cellular phone enclosed in the housing 10. The top portion 12 is configured to releasably fasten to the bottom portion 14 to enclose the cellular phone within the top and bottom portions of the housing. Snap fits or sliding tongue and groove connections along the edges of the top portion 12 are typically used in such releasable connections.

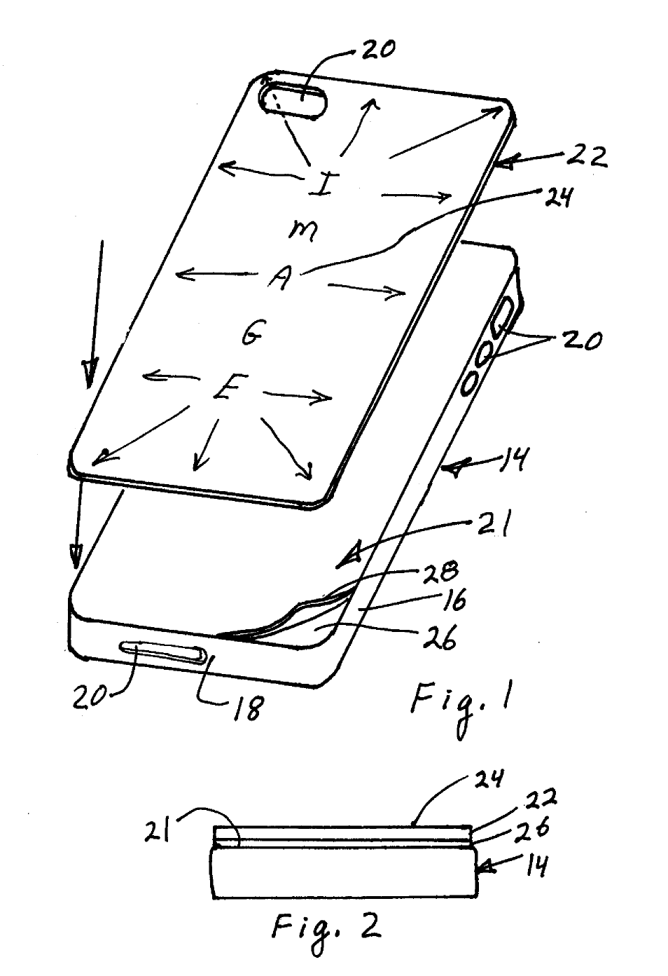

The back portion 14 of the case 10 preferably has a substantially flat, outward facing surface 21 onto which a support sheet 22 bearing image 24 is fastened, preferably by an adhesive 26 (FIGS. 1-2). A removable protective sheet 28 (FIG. 1) advantageously covers the adhesive on the outward facing surface 21 until the support sheet 22 is ready for fastening to the outward facing surface 21. Buy substantially flat is meant a surface varying by no more than about 10 mm across the substantially flat portion of a back portion 14 having as its largest dimension a length of about 150-200 mm, and preferably smaller. The image 24 may include text alone, numbers alone, images alone, or any combination thereof, and all of these are encompassed by reference to image 24.

The support sheet 22 is preferably shaped to substantially conform to the shape of the outward facing surface 21 and cover the entire surface except for any openings 20. By substantially conform is meant covering about 90% or more of the substantially flat surface 21, not including any openings 22 in the sheet 22. The image 24 also preferably conforms to the shape of and covers the entire surface of the support sheet 22 except for any openings 20. But the image 24 can be of diverse size and shape, and the support sheet 22 can also be of diverse size and shape. The shape of support sheet 22 is preferably, but optionally predetermined to fit onto a specific outward facing surface 21, and thus support sheet 22 will have openings 20 preformed in the support sheet 22 to generally conform in size and shape to the openings in the outward facing surface 21. By generally conforming is mean having a size and shape and location within about 10% of the size and shape and location of the openings 20 in the surface 21, and preferably within about 5% or less and most preferably within about 1% or less.

The support sheet 22 advantageously has one surface, its inner surface, adapted to be fastened to the outward facing surface 21, preferably by adhesive 26. The opposing, outward facing surface of support sheet 22 is adapted to receive a sublimation image to form image 24. The support sheet 22 is advantageously a thin sheet, preferably metal and more preferably made of aluminum. But support sheet 22 could be any suitable material having a first surface adapted to receive a sublimation coating and having a second, typically opposing surface adapted to be adhered or otherwise fastened to case 14. Various plastics or polymers are believed suitable for sublimation coating, including acrylic glass. If the sublimation coating temperature is suitably low, the support sheet 22 could be fabric or suitable paper-based materials. Support sheets having a thickness of about 1-2 mm or less are believed suitable, and advantageously having thicknesses of about 1 mm or less. The support sheet 22 advantageously conforms to the shape of the surface 21, and preferably is stiff enough to hold or retain that shape so that if the surface 21 is flat then the support is flat and if curved the support is curved.

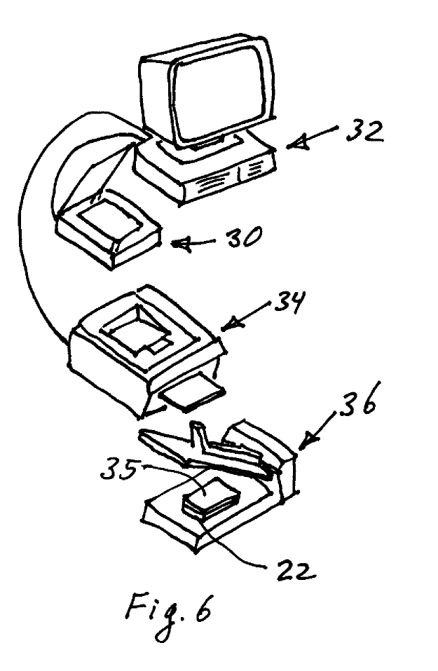

Referring to FIG. 6, the image 24 is applied to the support sheet 22 using sublimation dye transfer process. A digital image, such as a photograph from a digital camera or a digitally scanned image from scanner 30 is transferred to a computer 32 and modified as desired. The digital image is printed by printer 34 having cartridges containing sublimation colorants. As used herein, the term colorants refers to inks or dyes which may be used to form sublimation transfer images where heat is applied to the ink or dye causing the ink or dye to diffuse into a receptive surface or material.

The image is preferably printed by printer 34 onto a transfer sheet 35 adapted to receive the image printed using sublimation colorant. The sheet 35 will be used herein as having an image on it, with the image being adapted for sublimation transfer. The transfer sheet 35 is placed over the support sheet 22 and heat is applied as by a heated press 36. The printer may receive the image from computer 32, or directly from a transfer medium such as a camera card, CD, DVD, or other portable transfer device. Alternatively, the sublimation colorants may be printed directly onto a surface placed on carrier sheet 22 adapted to receive the sublimation colorant. If the support sheet 22 is not made of a material that can receive a sublimation image the support sheet 22 may have a coating applied thereto that is adapted to receive the sublimation image.

Referring to FIG. 5, a plurality of support sheets 22 may be placed on a suitable support sheet or conveyor 38 adapted to pass through a suitable heating device such as oven 40, with a suitable clamp 42 configured for the oven 40 applying sufficient pressure to the transfer sheet 35 and support sheet 22 for sublimation transfer of the image to the support sheet. Alternatively, a single transfer sheet 35 containing a plurality of images may be placed over a single, large support sheet 22 and a plurality of images transferred to the support sheet, with the individual support sheets 22 being cut to the desired shape from the single larger sheet. Further, if the colorant is printed directly onto a layer on the support sheet 22, the suitable pressure is provided to the sheet 22 and image. The use of heat transfer presses 36 and ovens and their variously configured, associated clamping mechanisms 42 lend themselves to operations where individuals send images to manufacturers who place the image onto support sheets 22 and return the images support sheet 22 to the individual, in exchange for payment of money. Alternatively, suitable pressure may be maintained by an elastic compression sheet wrapped around at least a portion of the support sheet 22. Such an elastic compression sheet is described in U.S. Pat. No. 8,002,931, the complete contents of which are incorporated herein by reference.

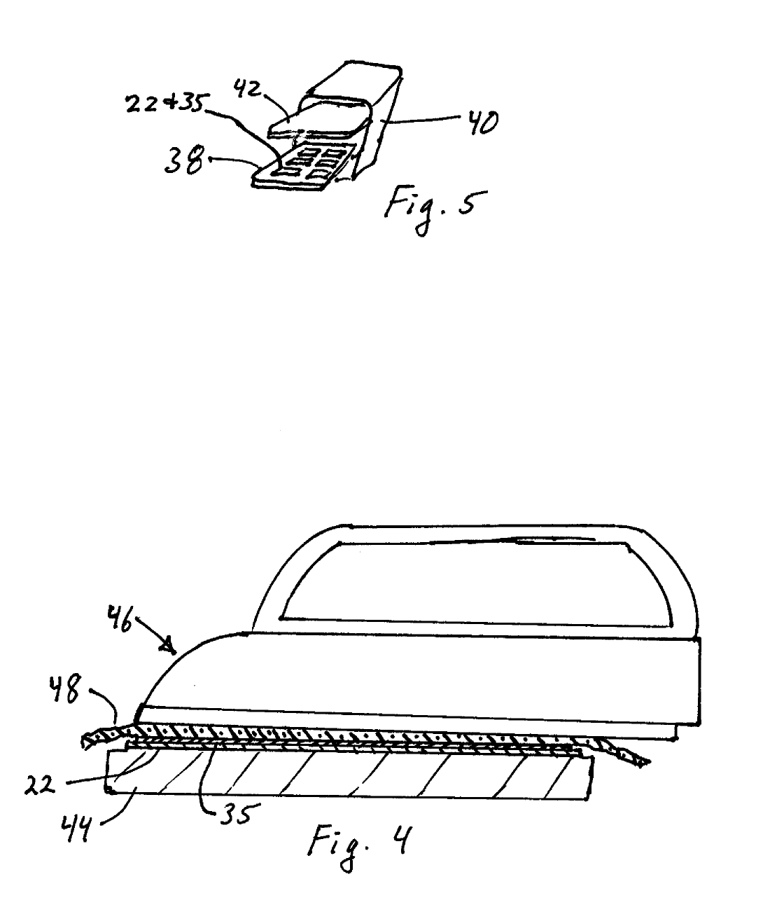

Referring to FIG. 4, not everyone has a heat press 36 or oven 40 suitable for sublimation transfer, so alternatively, the support sheet 22 is placed on a support such as counter top or table 44. the image transfer sheet 35 bearing the image is placed over the support sheet 22, and a clothes iron 46 may be used to manually apply heat to achieve the sublimation transfer. Advantageously, but optionally, an intermediate flexible material 48 such as a cloth, towel or sheet of paper may be interposed between the iron 46 and the transfer sheet 35 to moderate the temperature. This method allows an individual to print their own transfer sheet 35 and form their own image 24 on the carrier sheet 22, and fasten the imaged sheet 22/24 themselves. If a clothes iron 46 is used, the colorant used should be selected to be within the temperature range of the irons. Many sublimation colorants require temperatures of about 130° C. to complete the sublimation transfer, but lower temperature colorants are available.

Referring to FIG. 1, the support sheet 22 is preferably rectangular with rounded edges configured to fit onto the outward facing surface 21 of an I-phone 4G cellular phone, with an appropriate opening 20 located for the camera on the I-phone, and sized for the lens of that camera. The opening 20 advantageously has parallel sides and rounded ends. The support sheet 22 is adapted to receive a sublimation image 24, and thus has a receptive layer of polymer adapted to receive that image 24. Such sublimation transfer images are known in the art, such as by U.S. Pat. No. 7,709,417 to Yukawa and U.S. patent application Nos. 12/613,084 to Xu et al., U.S. application Ser. No. 11/413,734 to Xu. Et al, and U.S. application Ser. No. 12/760,768 to Hirst. The complete contents of each of these patents and patent applications are incorporated herein by reference.

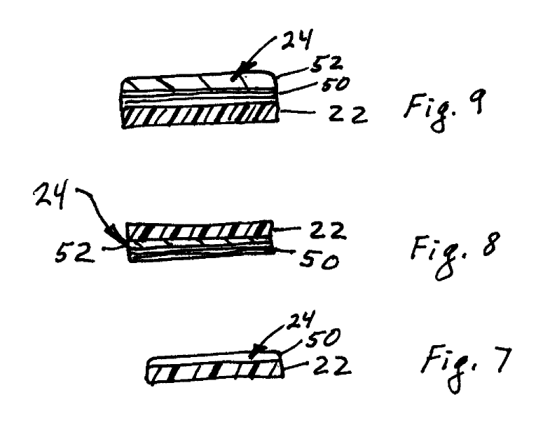

The image 24 may be formed in an outer layer of material on the support sheet 22, and is advantageously viewed against a white or colored background to increase contrast and visibility of the image. The white background may be provided by the color of the metal carrier sheet 22, especially if the sheet is aluminum. Thus, referring to FIG. 7, the image 24 may be formed in a receptive layer 50 that is bound to support sheet 22, advantageously bound to metal support sheet 22, and preferably bound to aluminum support sheet 22. The receptive layer 50 is any material suitable for receiving the sublimation transfer image 24, including polymers, with acrylics being believed suitable. The receptive layer 50 must not only receive the sublimation image, but must be suitably selected to bond to the support sheet 22. For those support sheets 22 that are not adapted to receive a sublimation image, the layer 50 allows such an image to be applied to the sheet 22.

Referring to FIG. 9, the image 24 may pass through a white opaque layer 50 as described in U.S. Pat. No. 7,709,417 and application Ser. No. 12/613,084 and be absorbed in clear layer 52 or into clear support sheet 22 itself (with layer 52 omitted).

Alternatively, as seen in FIG. 8, the image may pass through white layer 50 and into or fasten to clear layer 52 which in turn is bound to white layer 50 which is in turn bound to support sheet 22. This allows image 24 to be viewed against a white background for better visibility. Alternatively, if the support sheet 22 is capable of receiving image 24, the layer 52 may be omitted and the image 24 may form on or in the support sheet 22 directly abutting white layer 50, with the image 24 viewable through the support sheet and against the white backing 50. Thus, if the support sheet 22 is clear or translucent the image 24 may be placed initially on the back side of sheet 22 and white pass-through layer 50, with the sublimation heat transfer passing the image through the white layer 50 so as to be visible through the transparent sheet 22.

Referring to FIG. 1, after the dye transfer or ink transfer image 24 is formed on carrier sheet 22, the protective layer 28 is removed from the outward facing surface 21 of back 14 to expose adhesive layer 26. The support sheet 22 is placed against the adhesive sheet 26 to fasten the parts together. The cellular phone (not shown) is inserted into the back case 14 and the front 12 is then fastened to the back case 14 to enclose the cellular phone. If the image 24 is being viewed through the support sheet 22 then the sheet 22 is not made of metal, but is made of one of the polymers described in the patents and applications incorporated by reference. The adhesive layer 26 may be on the back of the supporting sheet 22, in which case the protective sheet or release sheet 28 is on the supporting sheet rather than on the back portion of the case 14.

The clear layer 52 is preferably a polymer layer which has high affinity to the thermally diffusible colorants used to generate image 24. One example is polyester, which is an excellent receptor for disperse and sublimation colorants. Advantageously, the overall glass transition temperature of the polymeric material(s), Tg, is preferably −20° C. to 100° C. The polymer may be polyester, polyamide, acrylic/acrylate, nylon, or other receptive polymer with high affinity to thermally diffusible colorants, or a combination thereof. The polymers may be a mixture of cross-linkable polymers. For example, a blocked polyisocyanate and a hydroxyl-functionalized polyester resin may be combined with a hot melt adhesive to form polymer layer 52. Upon application of heat during the transfer process, the polyisocyanate and hydroxyl-functionalized polyester cross-link to form a permanently bonded color image on the substrate. The polymer layer 52 may be applied to the release base sheet 10 by known methods such as aqueous-based coating, solvent-based coating, hot melt coating, extruded, transfer coating, or lamination. The dry coat weight of the polymer layer 52 may range from 5-60 g/m², and is preferably 10-30 g/m². Examples of polymer Layer 52

The white pass through layer 50 may comprise an opacifying agent or agents and suitable polymer binders. Preferable opacifying agents are white pigments, such as titanium dioxide, calcium carbonate, aluminum oxide, or zinc oxide, or combination thereof. Organic white colorants may also be used. Preferably, the opacifying agent or agents comprise 20-30% of the permeation opaque layer 50. The dry coat weight generally ranges from 5-60 g/m², and is preferably 10-45 g/m².

The white layer 50 may act as a binder to fasten layers together. This layer 50 is preferred to have little to no affinity for thermally diffusible or sublimation colorants that are preferred for use in forming image 24. An image layer comprising the diffusible or sublimation colorants may be printed directly on the white layer 52 rather than being printed on the transfer sheet 35. Upon heat transfer to a substrate, the disperse colorant diffuses and migrates through the permeable opaque layer 50 and into the polymer layer 52 with little to no retention of the colorant by the opaque layer 50 though which the colorant diffuses and passes. Preferred materials for the permeable opaque layer 50 are materials that bind the opaque layer to the substrate 22 or adjacent clear layer 52. Examples are, but are not limited to, cellulose and chemically modified cellulose, low density polyethylene, chlorinated polyethylene, polyvinyl chloride, polysulfone, polystyrene or crosslinked polystyrene, melamine/formaldehyde resin, phenol/formaldehyde resin, fluorinated polymers, siloxane and/or modified siloxane polymer materials, copolymers such as polytetrafluoroethylene, and polyvinylidene fluoride. Low molecular weight emulsion polymers, such as polyvinyl alcohol, polyvinyl acetate, or silicon based elastomers may be used. The polymer binders may have aliphatic structures without polyester functionality, which have no or low affinity for thermally diffusible colorants than aromatic polymer binders, allowing low colorant retention, high permeability and colorant diffusing/migration efficiency, and high image color density upon transfer to the substrate. The polymer binders may be cross-linkable.

The image receptive layer 52 may include materials which receive and retain colorants as it is printed, either by physical entrapment or chemical reaction. This layer 52 absorbs colorant drops from liquid inkjet printer, minimizing bleeding of the image, and maintaining a high definition of the image. In addition, the layer temporarily holds the thermally diffusible colorants from the colorant close to the surface of the transfer medium. The image receptive layer 52 may be tailored for use with any print method known in the art. For example, materials known in the art for forming inkjet or toner receptive paper coatings may be used according to appropriate applications.

Examples of materials that retain liquid through physical entrapment include, but are not limited to, porous materials such as silica gel, alumina, aluminum silicate, calcium silicate, magnesium silicate, zeolite, porous glass, diatomaceous earth, and vermiculite; liquid swellable materials such as montmorillonite type clays, such as bentonite and hectorite; and polysaccharides, such as starch, cationic starch, chitosan, grafted chitosan, dextrin, cyclodextrins, finely-divided organic pigments, such as polystyrene resin, ion exchange resin, urea resin, and melamine resin; and fillers, such as calcium carbonate, magnesium carbonate, kaolin, talc, titanium dioxide, zinc oxide, magnesium oxide, magnesium hydroxide, calcium hydroxide, and calcium sulfate. Examples of materials that retain liquid through chemical reaction include, but are not limited to, polymers based on methacrylate, acrylate, or the like; and monomers with suitable cross-linking agents such as divinylbenzene.

Water-soluble polymers, such as polyvinyl alcohol, modified polyvinyl alcohol, polyvinylpyrrolidinone, polyvinyl methyl ether, polyvinylbutyral, polyethylene imine, polyethylene oxide, cellulose derivatives, such as methyl cellulose, ethyl cellulose, methyl ethyl cellulose, hydroxypropyl cellulose, natural polymers, such as arabic gum, casein, gelatin, sodium alginate, and chitosin are typically used as binders. Water-insoluble polymers may be used as binders. Examples of such are styrene-butadiene copolymers, acrylic latexes, polyacrylamide, and polyvinyl acetate. The liquid retaining/receptive layer may contain chemicals which react irreversibly with water and/or solvents to render them non-volatile. An example is polyvinyl alcohol. Auxiliary agents may be included in the liquid retaining layer formulation such as ultraviolet absorber, thickener, dispersant, defoamer, optical brightening agent, pH buffer, colorant, wetting agent, and/or lubricant.

The image receptive layer 52 comprised of the above mentioned liquid retaining compounds and binder may be prepared in any ratio using one or more of each of the above mentioned liquid retaining compounds and binders. In one embodiment 5-50% binder is combined with 50-95% liquid retaining compound. A layer having 5-25% binder with 75-95% liquid retaining compound is believed suitable. The image receptive layer 52 may be applied to the opaque layer 50 by any known coating procedure. While various materials are possible to use when making the case 14, bottom portion 14 and the support 22, the materials must be compatible for the connection that is used to hold the parts together. Thus, while a variety of materials may be applied to a metal support 22 so that the support 22 can receive sublimation image 24, the materials that are selected should be compatible, rather than selecting materials that may receive sublimation image 24, but not adhere well to metal or not work well with the particular metal used for support sheet 22, such as aluminum.

The above description applies the supporting sheet 22 to an outwardly facing surface 21 that is preferably flat. But many cell phones have backs that have curved edges and for such cases the supporting sheet 22 is molded in a curved configuration to match the back of the cell phone. The sublimation image 24 is preferably located only over the flat portion of the housing, with the adhesive 26 similarly located.

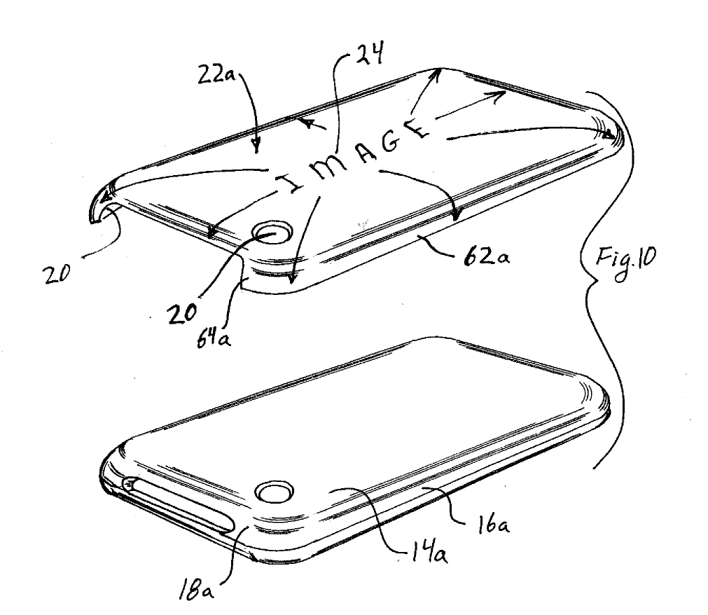

Referring to FIGS. 1 and 10, a support sheet 22a is shown having an outward facing surface 21a and having curved sides 60a and curved ends 62b shaped to conform to curved sides 16a and curved ends 18a of a curved bottom cover 14a. The curved surfaces 60a, 62a do not extend beyond 90° to recurve toward themselves and that allows the preformed support 22a to fit onto a curved back portion 14a having curved surfaces that conform with the curve of sides 60a and ends 62a. The image 24 is sublimation coated onto the support sheet 22a as before, and may have preexisting openings 20, or the openings 20 may be formed in the sheets 22a after the image is placed on the sheet. The support sheet 22a is fastened to the bottom 14a as described above, preferably using adhesives.

The above parts can be provided by a commercial establishment or manufacturer that takes an image provided by a customer, places the image 24 on the carrier sheet 22, fastens the sheet 22 to the back portion 14 of the case and sends the imaged case to the customer. Alternatively, the customer may send the image to a commercial establishment or manufacturer who puts the image on the supporting sheet 22 and sends the images sheet 22/24 to the customer, in which case the customer adheres the imaged sheet 22 onto the surface 21. Moreover, the parts can be provided in a kit so the customer can put a dye transfer image on the supporting sheet and fasten the sheet to the housing portion 14. An elastic clamp as described in U.S. Pat. No. 8,002,931 is especially suitable for low cost, consumer use. Further, that elastic clamp is especially suitable for applying the sublimation image 24 to a curved surface, and thus the outward facing surface 21 need not be flat, but may be curved or have a mixture of flat and curved portions.

The above description is given by way of example, and not limitation. While the above description is provided in terms of the outward facing surface 21 of the a cell phone, this invention is not limited to cellular phone cases but may be applied to other items having a case, housing or other surface which is adapted to receive a support sheet 22 bearing a sublimation image, optionally fastened using a suitable adhesive 26. Advantageously the outward facing surface 21 covers a large portion of the item's surface, and preferably covers almost all of the item's surface viewable when looking straight at the outward facing surface. That outward facing surface 21 is preferably flat, but may have a flat portion with curved sides and ends to conform to the shape of the ends and sides of the object to which the support 21 is fastened.

Further, instead of adhesive 26, the support 22 may be fastened to the case 14 by any suitable means that does not destroy the image 24, including, but not limited to ultrasonic welding, friction welding, melting, staking, or recesses shaped to receive support 22 with overlapping snap-together holders. Thus, given the above disclosure, one skilled in the art could devise variations that are within the scope and spirit of the invention disclosed herein, including various ways of fastening the support sheet 22 to the bottom case 14 or fastening it to other surfaces, or other ways of forming the image 24 on the support sheet 22 using sublimation transfer. Further, the various features of the embodiments disclosed herein can be used alone, or in varying combinations with each other and are not intended to be limited to the specific combination described herein. Thus, the scope of the claims is not to be limited by the illustrated embodiments.

1. A decorative case for a cellular phone having a predetermined shape, comprising:
a back portion of a cellular phone case, the back portion having a back, opposing sides and opposing ends configured to closely fit over the back and sides of the cellular phone, the back portion having an outwardly facing, substantially flat portion;
a supporting sheet having an inner surface adhered to the substantially flat portion and an outward facing portion having a sublimation image thereon.

2. The case of claim 1, wherein the substantially flat portion covers the entire back of the cellular phone.

3. The case of claim 1, wherein the supporting sheet is made of metal.

4. The case of claim 1, wherein the supporting sheet is made of aluminum.

5. A kit for decorating a case for a cellular phone, the phone having a predetermined shape, comprising:
a back portion of a cellular phone case having a back, opposing sides and opposing ends configured to closely fit over the back of the cellular phone, the back portion having an outwardly facing, substantially flat portion;
a supporting sheet configured to conform to the shape of the substantially flat portion, the supporting sheet having an outward facing portion having a surface adapted to receive a sublimation colorant;
an adhesive on one of the substantially flat portion or the supporting sheet; and
a removable layer abutting an outward facing surface of the adhesive for covering the adhesive and releasable therefrom to fasten the adhesive to the supporting sheet.

6. The kit of claim 5, further comprising a transfer sheet having a surface for receiving sublimation transfer colorants and having a portion conforming to the shape of the substantially flat portion.

7. The kit of claim 5, wherein the supporting sheet has a sublimation image on a surface that is adapted to receive a sublimation colorant.

8. The kit of claim 5, wherein the substantially flat portion covers the entire back of the cellular phone.

9. The kit of claim 5, wherein the adhesive is on the substantially flat portion.

10. The kit of claim 5, wherein the adhesive is on the supporting sheet.

11. The kit of claim 5, wherein the supporting sheet is made of metal.

12. The kit of claim 5, wherein the supporting sheet is made of aluminum.

13. The kit of claim 5, further comprising a top portion of the case configured to releasably fasten to the bottom portion around a periphery thereof to enclose the cellular phone within the top and bottom portions of the housing.

14. The kit of claim 5, wherein the support sheet is of aluminum with a thickness of 1 mm or less.

15. The kit of claim 5, wherein the support sheet has an opening therein located to coincide with a camera lens on the cellular phone.

16. The kit of claim 5, wherein the support sheet has openings located to correspond with the camera lens on the back of an I-Phone 4G cell phone.

17. The kit of claim 5, wherein the support sheet has an opening located to correspond with the camera lens on the back of an I-Phone 4G cell phone.

18. The kit of claim 5, wherein the support sheet has sides and ends which are curved.

19. The case of claim 1, wherein the supporting sheet is rectangular.

20. The kit of claim 5, wherein the supporting sheet is rectangular.
